(19) United States
(12) Patent Application Publication
(10) Pub. No.: US 2014/0109654 A1
(43) Pub. Date: Apr. 24, 2014

(54) Method and Apparatus for Assessing the Consumption of a Medium in a Supply System

(71) Applicants: Lars Leblang, Frankfurt am Main (DE); Jochen Ohl, Gross-Umstadt (DE)

(72) Inventors: Lars Leblang, Frankfurt am Main (DE); Jochen Ohl, Gross-Umstadt (DE)

(73) Assignee: TECHEM ENERGY SERVICES GMBH, Eschborn (DE)

(21) Appl. No.: 14/125,589

(22) PCT Filed: Jun. 13, 2012
(86) PCT No.: PCT/EP2012/061203

§ 371 Date: Dec. 12, 2013

(30) Foreign Application Priority Data
Jun. 15, 2011 (DE) 102011105778.5

(51) Int. Cl. G01M 3/04

(52) U.S. Cl. CPC G01M 3/04
USPC 73/40.5 R

(57) ABSTRACT

Method and a device for assessing the consumption of a medium in a supply distribution system using at least one consumption meter, in which the consumption flow values (\dot{V}) of the medium consumed are determined based on the consumption values measured over time (V_{cum}) by the consumption meter. Thereby, a frequency distribution is generated using the consumption flow values (\dot{V}), and the consumption is assessed by analyzing the frequency distribution.

The invention relates to a method and a device for assessing the consumption of a medium in a supply distribution system for this medium, in particular, a budding, i.e. a supply distribution system by means of which this medium, is spatially distributed in a system, in particular, a building, and in which a targeted consumption of the medium occurs at various locations in the system. The method uses at least one consumption meter in which, by using the metered consumption values of the consumption meter that are captured over time, consumption flow values for the medium are determined, by means of which the targeted consumption of the medium by a consumer is captured as the consumption measured over time. The consumption flow values describe the flow of the medium in the supply distribution system at the location of the consumption meter. This means that the meter captures a withdrawal of the medium from the supply distribution system at a location downstream of the consumption meter.

Methods of this type are used in addition to the actual consumption measurement, for example, for detecting leaks in a water supply distribution system in buildings, whereby the leakage detection should be able to detect a burst pipe, an unauthorized withdrawal of water and/or a leakage with minimal water discharge.

Thus, DE 10 2004 016 378 describes the measurement of a relative decrease in pressure by a nozzle to determine a static state during which all consumers are shut off, or a uniform level of medium withdrawal is present. If this static state has been achieved for a certain period of time, the nozzle is systematically closed during an operation for detecting a leakage, and the inlet pressure is measured.

Further, the decrease in pressure is determined in the part of the pipe system that is shut off in order to draw a conclusion about a possible leakage. Hereby, it is disadvantageous that a separate measurement process must be performed to determine the leakage, which can, under certain circumstances, impede a user because the water or the supply of the medium is interrupted for this purpose. Conversely, user withdrawals during the measurement process can falsify the measurement result.

The basic idea of DE 10 2006 013 610 B4 lies in sending an information signal obtained in the consumption meter to a monitoring device that is already provided in the building, which is a part of a network having several of these monitoring devices. This information signal is then transmitted from this monitoring device to at least one additional monitoring device as a signal triggering an alarm. Detecting leaks by using this system customarily functions in such a way that a leakage is assumed for a flow extending over a long period of time. However, this is imprecise, because in a long-lasting garden irrigation, for example, such a state can also be present during normal operation.

Finally, WO 2007/047847 A2 discloses a method for an automatic detection of an abnormal consumption using a consumption measurement device in which the consumption is determined by the consumption measurement device and subsequently compared with the problem/incident criterion. As suitable criteria, for example, thresholds in the consumption flow within an analysis interval are used. The occurrence of such events is counted and upon exceeding a certain number of such abnormal consumption events within an observation interval, an alarm signal is transmitted. This process provides that the criteria are adaptable by using a self-learning method.

DE 197 06 564 A1 describes the detection of a water leakage and a stop device for a household in which a flow volume counter with an electronic measurement value output is located in the supply pipe element of a pipe system and an additional flow volume counter is mounted to detect smaller sources of leakage. By using predetermined or programmable algorithms, leakage points are identified based on individual sensor signals in this system and throttling or blocking processes are initiated. As criteria for the comparison with a respectively measured single value of a flow volume meter, instances of exceeding a predetermined flow volume, a continuous flow rate of the smallest degree, or a deviation of the rate of flow from a stored consumption pattern that had been found by way of an adaptation process are used. The consumption patterns are captured in memory as quantitatively and chronologically connected consumption events. The individually measured consumption events are then compared with these standard values that specify a correlation of volume and time. This renders the proposed method rather inflexible so that even standard consumption events that occur at different times representing exceptions, can lead to an erroneous shut-off.

All of these methods for assessing consumption described above have the problem that individual consumption values captured by a consumption meter are respectively compared with a threshold value in order to determine critical or extraordinary consumption values. However, this is frequently not appropriate, as depending on the consumption behavior, specific consumption values can mean an abnormal consumption behavior in one case (for example, in the case of a leakage) and in a different case, a normal consumption behavior (for example, a garden irrigation).

DE 692 09 624 T2 describes a statistical determination of fluid leakage in a pipe in which, for example, the fluid volume is measured over a certain period of time between a first and a second instant of time at a position in the pipe, and a statistical probability is calculated for the measured distribution under the assumption that no leakage occurs, as well as under the assumption that leakage does occur. Then, that assumption having the greater probability is selected as being true and is attributed the measured distribution. If appropriate, an additional measurement at various instants of time can take place at a second location of the pipe. The theoretically assumed statistical distributions can, in particular, be Gauss normal distributions with substantially equal variances, but with different average values. The basic concept lies therein, that measurements are taken within a time interval for which theoretically, no change of the measured flow (fluid flow volume) occurs, and it is then determined by means of an adaptation (fit according to the Wald sequential likelihood ratio test), whether the behavior of the measured distribution more likely corresponds to a distribution with or without leakage. Correspondingly, the invention relates only to the testing of a transport pipe in which a fluid flows in the absence of a planned withdrawal of fluid. The system is not suitable for a consumption supply distribution system within a building in which routine withdrawals can occur during the measurement process, because the system is not in a position to process different levels of nominal consumption.

It is therefore the objective of the present invention to achieve a more reliable assessment of the consumption of a medium in a consumption supply distribution system, in particular, with the help of the consumption flow values that were captured.

According to the invention, this problem is solved with the features of the coordinated claims 1 and 13 that address a method and a device equipped to implement the method.

In particular, it is provided in the proposed method that from the consumption flow values, i.e. the consumption flow values captured within the scope of the measurement of consumption by the consumption meter, a frequency distribution is generated and the consumption is assessed by an analysis of the frequency distribution. The advantage of this method according to the invention lies therein, that the detection or the assessment of an extraordinary consumption pattern is not made based on a single value, but based on the frequency of the various consumption flow values, in particular, relative to each other, without taking a certain chronological correlation between the various consumption flow values into consideration. Chronological correlation information is no longer evident in the frequency distributions. Hereby, a better detection of “normal” consumer behavior and “abnormal” consumer behavior can be achieved. In the following, the abnormal consumption behavior is also referred to as leakage, without being absolutely limited to an occurrence of an unexpected or undesired discharge of the medium from the supply distribution system.

Thus, according to the invention, it is not single consumption events that are assessed, be they individual measurement values or the consumption of several measured values of a chronologically longer lasting consumption, for example, within the scope of a garden irrigation, but the consumption measurement values of the consumption meters that are already captured within the scope of the consumption measurement over the interval are collected in a frequency distribution, which is then analyzed. Therefore, in contrast to the known methods for detecting a leakage, according to the invention, it is not single consumption events that are assessed, which could be captured as a single measurement or as multiple measurements in a defined interval, but the normal consumption values are collected in a frequency distribution and analyzed. Thus, the method according to the invention uses a supply distribution system that is equipped with a consumption meter in which over time, the consumption values of the consumption meter can be captured as consumption flow values in order to determine a leakage that is based on the frequency distribution of these values. In contrast to known methods, the method according to the invention, is therefore not suitable for identifying single consumption incidents as leakage in the supply distribution system and, for example, initiate blockage measures immediately. The analysis of the frequency distribution over a longer time interval in which, according to the invention, the occurrence of nominal consumption of the medium, for example, by a withdrawal of water occurs, makes it possible to identify a chronologically persistent leakage, precisely also of smaller amounts of leakage that do not necessarily draw the attention of the consumer without having to install additional measurement devices in addition to the consumption measurement devices already present, or perform additional measurements. Thus, according to the invention, the consumption measurements of the consumption meters are also used to detect leakages. During this time interval, different nominal measurement values occur because of the targeted consumption; these are analyzed in the frequency distribution.

In particular, according to the invention, the medium distributed in the supply distribution system can be water, gas or another fluid. That is why especially consumption value detections in buildings are areas of application, but also the technical monitoring of systems. Finally, in place of a fluid, the medium can also be, for example, a flow for which a leakage, for example, a surface leakage can be present. Correspondingly, consumption meters according to the invention can also be water meters, gas meters or generally, fluid meters, for which the proposed method is particularly suitable. However, a possible application also results, as has already been mentioned, for electricity meters or other consumption meters. When the medium is a fluid, the consumption flow value, in particular, can be a volume flow value.

For fluids, a leakage can be a burst pipe with a large volume of discharge of fluid, as well as a leakage with a minimal discharge of fluid. This results in different consumption patterns that must be analyzed. By using individual values, it cannot be determined if a typical or non-typical consumption pattern or normal or abnormal consumption is present. In the case of electric current, the proposed method is particularly suited to determine high electric current consumption, for example, a higher consumption by a certain consumer within a building to determine periodicities, for example, an old refrigerator, and the occurrence of continuous electricity leakages.

The advantage according to the invention lies therein, that no limit values must be specified for individual consumption flow values, but that an assessment of the consumption is made relative to the frequency distribution that has been generated respectively. Thus, for example, even for the detection of a permanent flow rate, no limit value or threshold value needs to be specified, so that the method is suitable for the detection of small consumption flows exceeding a start-up threshold of a consumption meter, as well as for large consumption flows. As the result of the analysis of the frequency distribution, the amount of leaked electricity consumed, for fluids, in particular, the leakage volume flow can also be determined, as will be explained in detail later. Thus, by creating and analyzing the frequency distribution, it is not the instantaneous values of the consumption flow that are being considered, but the consumption flow is analyzed over a definable time interval.

A typical metering technology that is suitable for performing the proposed method relates to meters according to the invention that serve the purpose of capturing fluid or gas volume to calculate consumption. These types of meters customarily have a volume sensor, a transmission interface and an analysis and/or display unit that is also described as meter. The volume sensor captures the volume stream of the fluid as consumption flow, i.e. the amount of fluid flowing past the meter during a specified time interval. This volume flow is transmitted to the meter by the transmission interface which then customarily displays the cumulative volume, or more generally, the accumulated consumption in the units measured.

The transmission of the consumption flow to the meter can occur continuously, for example, by mechanical impeller meters with magnetic coupling, or discontinuously via pulses, for example, electronically scanned volume sensors. Thereby, a transmitted pulse stands for a certain consumption or consumption flow increment, in particular, a volume or volume flow increment. Alternatively, the consumption flow can also be determined with an ultrasound counter, for example, which transmits ultrasound waves in and against the direction of flow of a fluid medium and measures a delay time of the ultrasound waves. The direction of flow depends on the rate of flow of the medium and thus permits the determination of a volume flow or volume increments.

As the proposed method requires an analysis function that can, for example, be realized in a microprocessor of a meter, it is assumed in the following that the meter makes a discontinuous transmission of pulses, i.e. volume increments available. Mechanical meters with continuous transmission using additional modules that scan the displaceable mechanics, can convert the analog signals into digital signals (analog/digital converter), which are likewise equipped with microprocessor-based analysis units. In this microprocessor unit, or more general, computer, the method proposed according to the invention can then be realized.

According to a preferred embodiment of the proposed method, the consumption flow values for forming the frequency distribution are classified into at least two, but preferably into more consumption flow classes. The frequency of the occurrences of consumption flow values is then respectively counted as an entry in a consumption flow class. This corresponds to generating a histogram in which the consumption flow values are associated with certain consumption flow value classes.

Preferably, the consumption flow classes can be defined by specifiable limit values, i.e. by the user and/or operator of the supply distribution system and/or an implemented learning process that is configurable in the processing unit. Methods in which an upper as well as also a lower limit can be specified are especially suited, whereby this can also be achieved by specifying a limit value and a value interval that is based on this limit value. According to a preferred embodiment of the invention, the upper limit value of the consumption flow class corresponds to the lowest consumption flow values, hereinafter also referred to as the “first consumption flow class”, the start-up consumption flow or the start-up volume flow of the consumption meter. Thus, according to the invention, the first consumption flow class describes a state without any measured or measurable consumption.

According to the invention, the frequency distribution can also be generated based on a specifiable time interval that is configurable by the user during installation and/or by the operator of the supply distribution system and/or by an implemented learning process. For example, it is also possible to adapt the time interval to be analyzed to the requirements of the system and/or the installation subsequently, during running operations, for example, by remote access. Reasonable intervals for analysis are, for example, six, 12 or 24 hours. If appropriate, a segregation by the time of day with typical consumption patterns, for example, early morning, morning, noontime, afternoon, evening, night, etc. can be used. At the latest upon the elapse of an analysis interval, but perhaps also continuously, or virtually continuously, while the frequency distribution is being generated, an assessment is performed.

Preferably, several analysis intervals of the frequency distribution are stored for a certain analysis period, for example, a week, a month or the like, so that a comparison of different frequency distributions in different time intervals can also be performed. In this case, it can also be provided according to the invention that several frequency distributions are summarized to determine long-term average values. Thereby, comparisons of summer, winter and the entire year can, for example, be made, and if appropriate, archived. After the elapse of the analysis interval and the analysis of the actual frequency distribution that typically follows, the actual frequency distribution is reset (i.e. the actual frequency distribution is reset to zero). Subsequently, a new, actual frequency distribution is determined, whereby the previous actual frequency distribution is being saved or has been saved, if appropriate, as previously mentioned.

According to a particularly preferred embodiment of the invention, for an analysis of the frequency distribution, the number of consumption flow values, the number of consumption flow values within consumption flow value intervals and/or the number of consumption flow values within consumption flow classes can be compared with specifiable threshold values and/or with the number of at least one other consumption flow value, the number of consumption flow values within at least one other consumption flow value interval and/or the number of consumption flow values within at least one other consumption flow class. Relative to the number of consumption flow values, the threshold values can be absolute values or relative values, whereby, in particular, relative values can be relative to the total number of the consumption flow values contained in the frequency distribution. In this context and relative to this application, this means the number of consumption flow values and the number of consumption flow values present that have precisely this value (for example, in the way they are formed in a digitalization of the measurement values), as well as the number of consumption flow values within the consumption flow classes that are defined by an upper and a lower limit value, as well as the number of consumption flow values within otherwise defined consumption flow value intervals. In particular, this applies when the various alternatives are not explicitly cited.

According to a preferred refinement of the proposed method, the threshold values can be learned, for example, by calculating an arithmetic average from the frequency distribution for intervals in which normal consumption behavior was present without any leakage or other abnormal influences. This can preferably take place during installation or testing of the supply distribution system. It is also possible that the user or operator is authorized to define this type of learning interval, for example, depending on particularities of the system during operation, perhaps also by remote access.

According to a further possibility that can be performed in addition or as an alternative to the analysis of the frequency distribution it can be provided that a reference frequency distribution is formed and compared with a generated frequency distribution, in particular, the respectively current frequency distribution. This comparison can be performed by preferably comparing the number of consumption flow values in the actual frequency distribution with the number of the consumption flow values in the reference frequency distribution, whereby the difference that is formed, for example, by a deviation in the number, is compared with a specifiable threshold value that can be adjusted or to which parameters can be assigned, i.e. during the installation and/or later by a user, administrator, or is automatically compared by a configuration unit. This threshold value can be an absolute or a relative value, whereby the special advantage of the analysis of frequency distributions is achieved particularly then, when it, and if appropriate also the additionally mentioned threshold values, are relative threshold values, i.e. these threshold values are determined relative to the total number of the entries in the frequency distribution. This also makes it possible to perform a trend analysis while the consumption flow values are being collected in the frequency distribution already. In addition, preferably after the elapse of the chronologically defined analysis interval, an absolute consumption flow can then be assessed within this time interval.

In particular, a reference frequency distribution according to the invention can also be learned by adding the determined consumption flow values to the reference frequency distribution. This can occur by directly transferring the consumption flow values from a selected interval of which it is preferably known that normal consumption conditions are present and that no leakage has occurred. Alternatively or in addition, a reference frequency distribution that is already available can be adapted. To do so, in the available reference frequency distribution, a weighting of the available number of consumption flow values and the number of the actually determined consumption flow values can be calculated, if appropriate, also by considering the analysis interval. To take the analysis interval into consideration, a chronological standardization can be used, for example. Corresponding to the definition further above, the number of consumption flow values present can also be the number of consumption flow classes or consumption flow intervals.

A further alternative or additional possibility for the analysis of the frequency distr bution lies in the analysis of the relative number of consumption flow values with a membership function that is associated with this consumption flow value, whereby the analysis of the membership function of various consumption flow values is summarized to assess the consumption or the total consumption. Thereby, the number of a consumption flow value can be the number of an individual value of a consumption flow, for example, as it is specified by a digitalization, but also the number of entries in a consumption flow class or a consumption flow interval, as it is already given from the generally pertaining definition. Even a summary of the membership functions of various consumption flow values can be achieved by a corresponding membership function, for example, by a tabular assessment of the summarizing membership functions and association of new membership functions with the result of the assessment.

If appropriate, in addition to the assessment of the consumption of an individual consumption meter, but also as sole method of analysis, in the previously described method, the consumption flow value, or a consumption flow value that is to be monitored can be formed based on the difference of the consumption flow values of two consumption meters. The difference of two individual consumption meters, a consumption meter and a consumption meter group, i.e. the summarized consumption of a group of consumption meters, or two consumption meter groups is then entered into the frequency distribution, and this difference is analyzed. This method is especially expedient in supply distribution systems with one primary meter and at least one secondary meter or a group of secondary meters, in order to detect that medium is being stolen between the primary meter and the secondary meter(s), or a leakage in the distribution pipe. To do so, the difference is formed according to the invention between the primary meter, for example, of a building at a central water main, and the summation of secondary meters downstream of the primary meter, or an individual apartment meter, or a group of several apartment meters.

By using this method, medium being stolen, or the leakage in the distribution pipe can be determined, because the primary meter captures the medium, not however, the secondary meter or the summation of secondary meters downstream of the primary meter. According to the invention, the proposed method can be performed in a consumption meter or in a data collection point. A data collection point shall mean a unit to which the individual consumption meters transmit the consumption values. The advantage of a data collection point lies therein, that the individual consumption meters can be designed simpler, because the methods for an assessment do not need to be installed or implemented there. In the data collection point, all consumption values required for the performance of the required method are present anyway. Here, a statistical analysis of the frequency distribution, or the frequency distributions, is possible in a simple manner. If applicable, the data collection point can be equipped to inform a control station, a control center or the like or make the assessment of the consumption available to a portal where it can be retrieved by the user and/or operator of the supply distribution system.

In a refinement of the proposed method, when a leakage of a medium is detected in the supply distribution system, preferably, the amount of the medium withdrawn can also be determined from the frequency distribution of the individual consumption values. To do so, the numbers of the consumption flow values, consumption value intervals, or consumption value flow classes are determined and from these, conclusions are drawn about the amount of the volume of a fluid discharged, or generally, the consumption of the medium during the capture interval. To accomplish this, the capture interval is either also captured and assigned to the consumption flow value as measurement value pair, alternatively, the consumption flow values can also be captured during regularly specified and known time intervals, so that from such the time between two consumption values and thus the time associated with the consumption flow is known.

The invention further relates to a device for assessing the consumption of a medium in a supply distribution system for this medium using at least one consumption meter, whereby the device has a memory for storing the consumption values of at least one consumption meter and a processing unit attached to the memory device, which is equipped to assess the consumption with the aid of captured consumption values. In particular, this assessment is achieved thereby, that the processing unit is equipped to perform the previously described method or parts of such.

According to the invention, the device can be integrated into a consumption meter. This can, for example, also be a primary meter in which the consumption values of secondary meters are also captured and stored. In particular, consumption meters, according to a preferred application, can be water meters in a building without limiting the principle proposed according to the invention to these types of meters. Alternatively or additionally, the device according to the invention can also be integrated into a data collection point which is connected to at least one consumption meter, but preferably, a number of consumption meters. The data collector can, in particular, be the data collector of a consumption capturing system within the scope of consumption cost capturing in real property.

In the already described especially preferred application of the method in water meters, or generally fluid meters, the consumption flow can, in particular, be formed by a volume flow.

In contrast to prior art, the present invention offers a significantly more secure basis for the analysis of the consumption and the detection of unusual consumption behavior, for example, as the result of a leakage or the stealing of medium between the primary meter and the secondary meter, because of the analysis of frequency distributions of consumption flow values.

Further advantages, features and possibilities of application of the present invention also result from the following description of exemplary embodiments and the drawing. Thereby, all described and/or pictorially shown features by themselves, or in any combination, form the subject matter of the present invention, regardless of their summary in the claims or their reference.

Shown are:

FIG. 1 shows consumption flow values (volume flow) for a first analysis interval calculated from metered consumption values captured over time by a consumption meter;

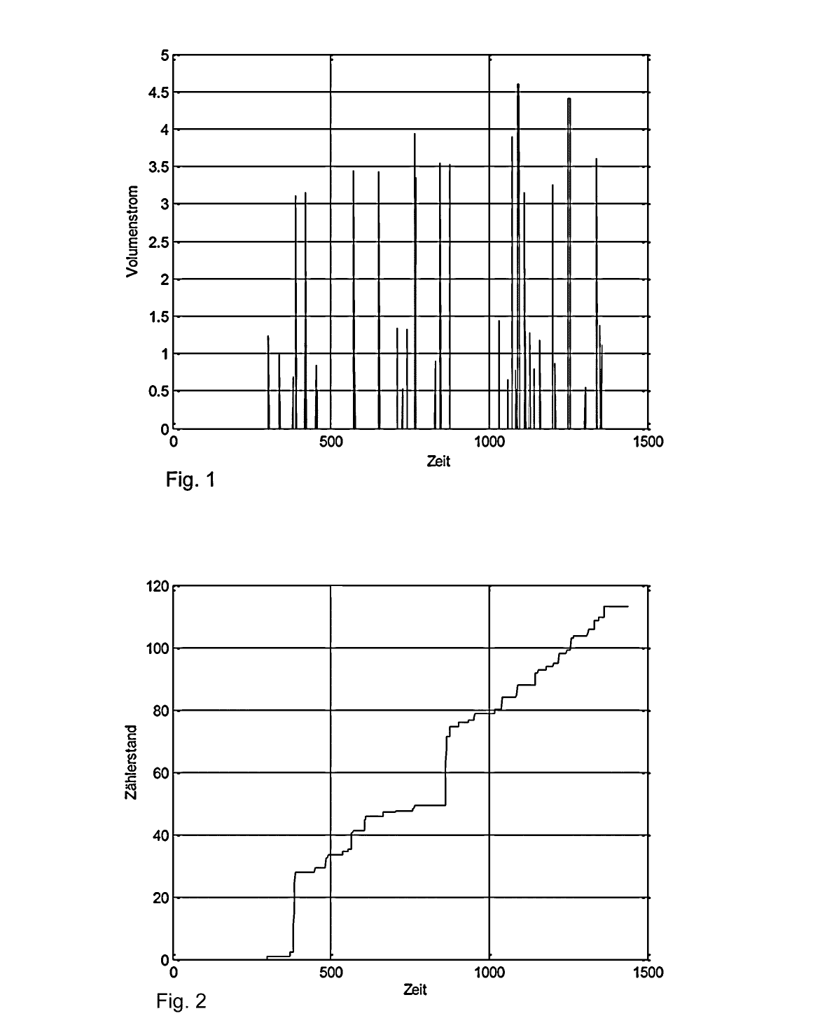

FIG. 2 shows the cumulative metered consumption values (meter reading) of the consumption meter pertaining to the first analysis interval;

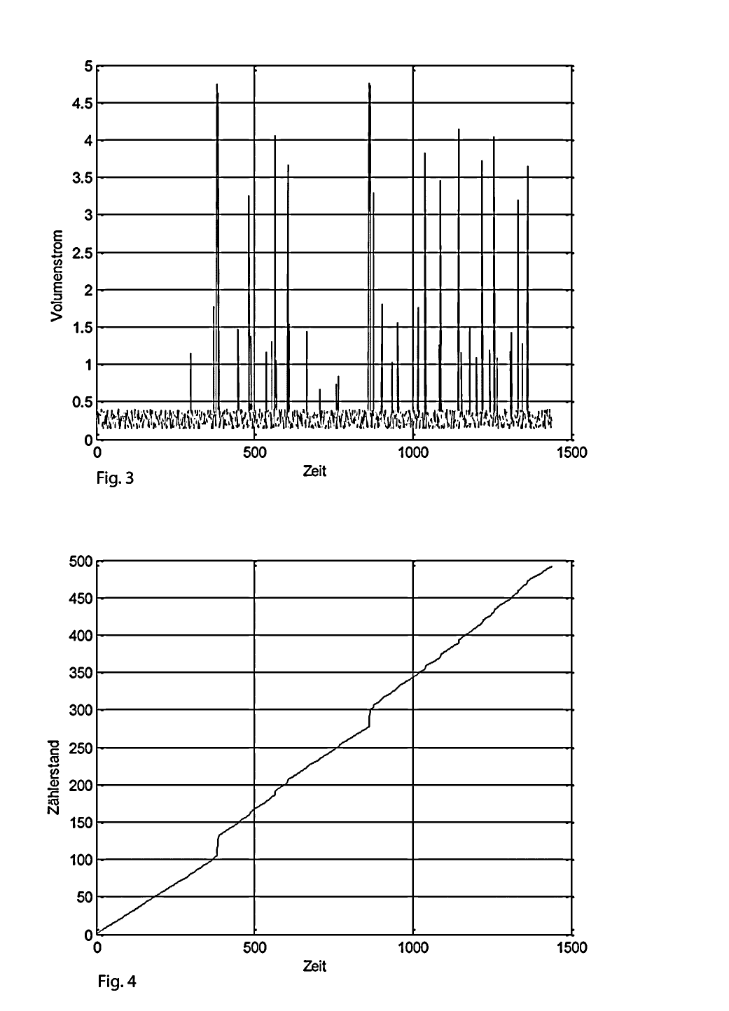

FIG. 3 shows consumption flow values (volume flow) for a second analysis interval calculated from metered consumption values captured over time by a consumption meter;

FIG. 4 shows the cumulative metered consumption values (meter reading) of the consumption meter pertaining to the second analysis interval;

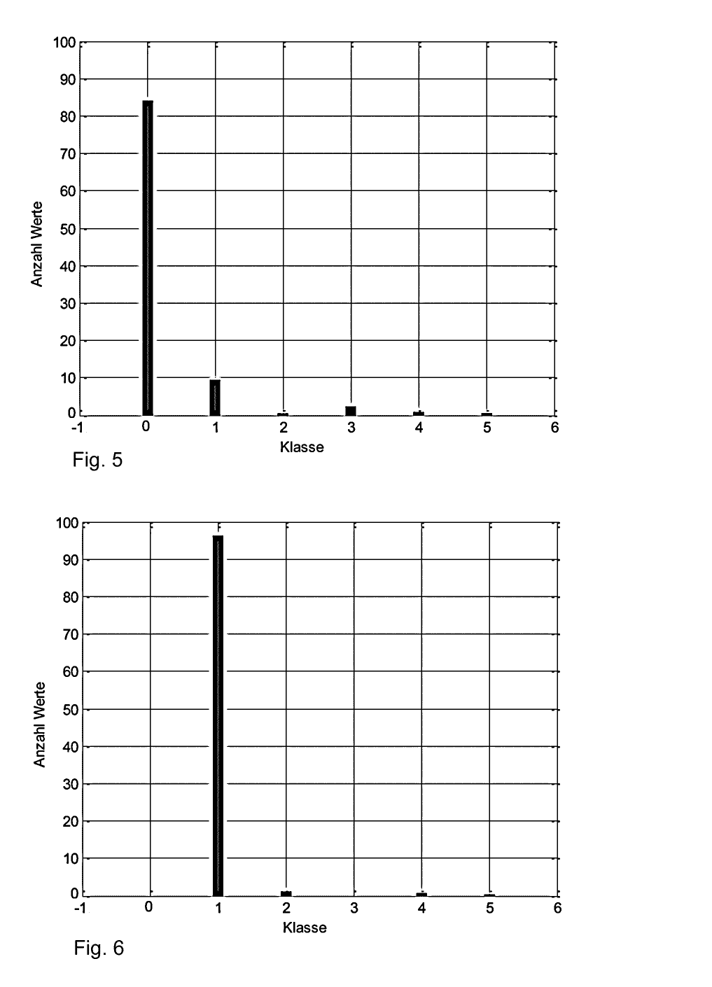

FIG. 5 shows a frequency distribution generated according to the invention for the consumption flow values determined according FIG. 1;

FIG. 6 shows a frequency distribution generated according to the invention for the consumption flow values determined according FIG. 3;

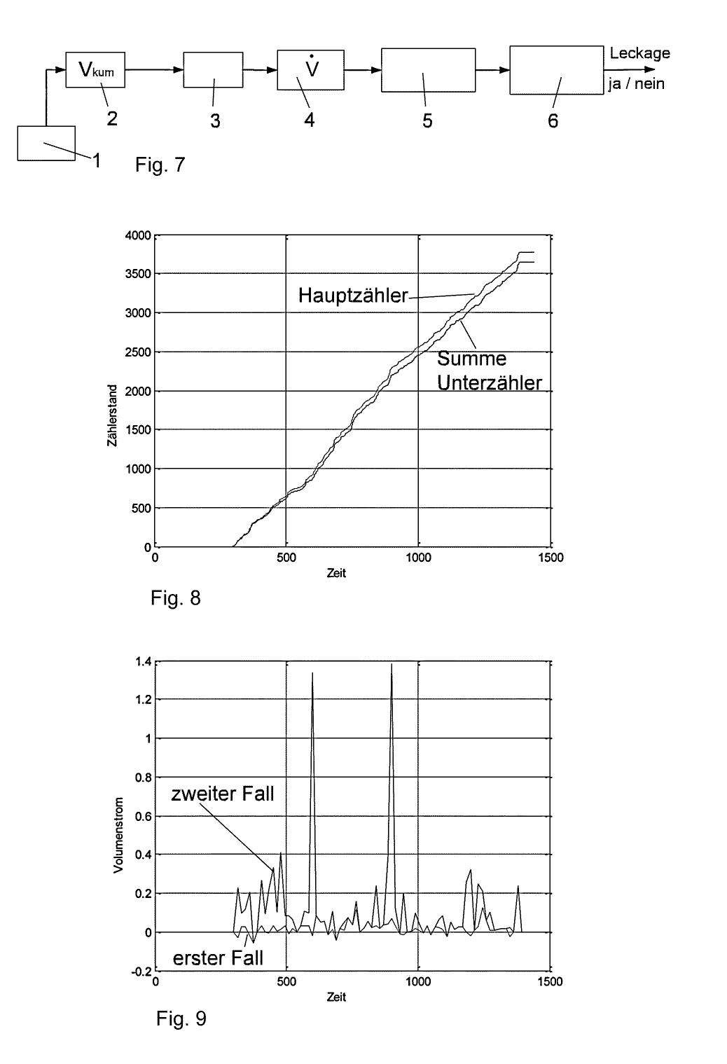

FIG. 7 shows a flow diagram of a first embodiment of the method according to the invention for assessing the consumption of a medium in a supply distribution system;

FIG. 8 shows the cumulative metered consumption values (meter reading) of two consumption meters captured over time, whereby one of the consumption meters is a primary meter and the other consumption meter is a secondary meter;

FIG. 9 shows the consumption flow values (volume flow) calculated from the metered consumption values captured over time as the difference of two consumption meters for a first and a second case;

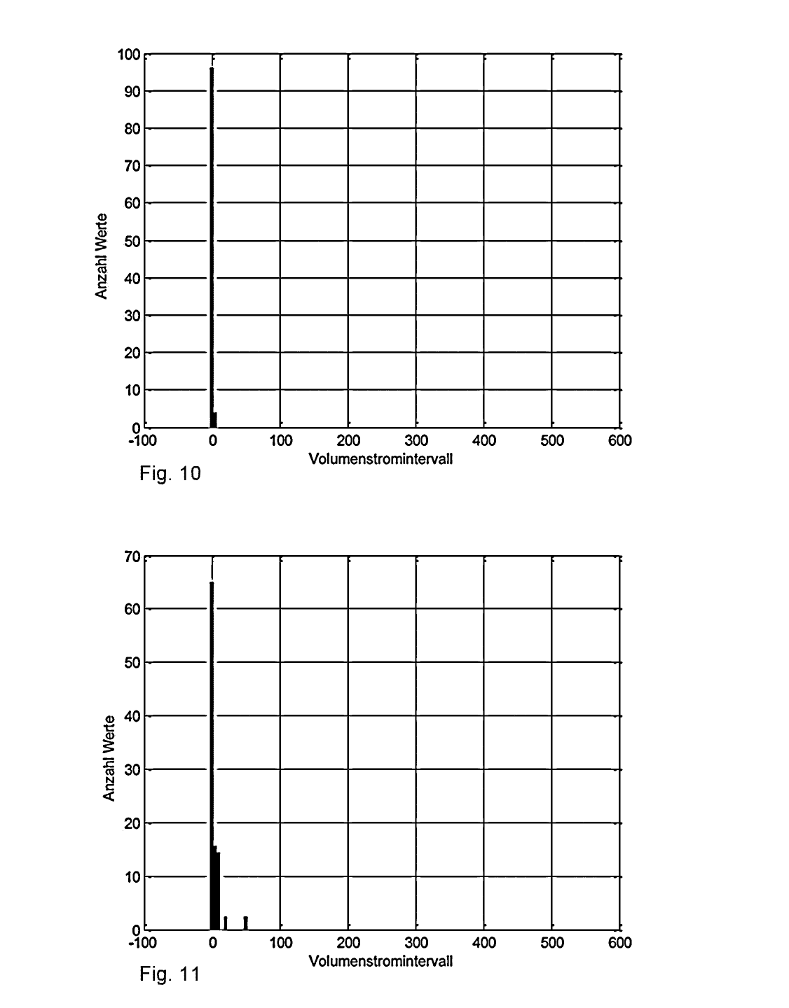

FIG. 10 shows a frequency distribution generated according to the invention of the difference of the consumption flow values (volume flow interval) of the two consumption meters in the first case according to FIG. 9;

FIG. 11 shows a frequency distribution generated according to the invention of the difference of the consumption flow values (volume flow interval) of the two consumption meters in the second case according to FIG. 9;

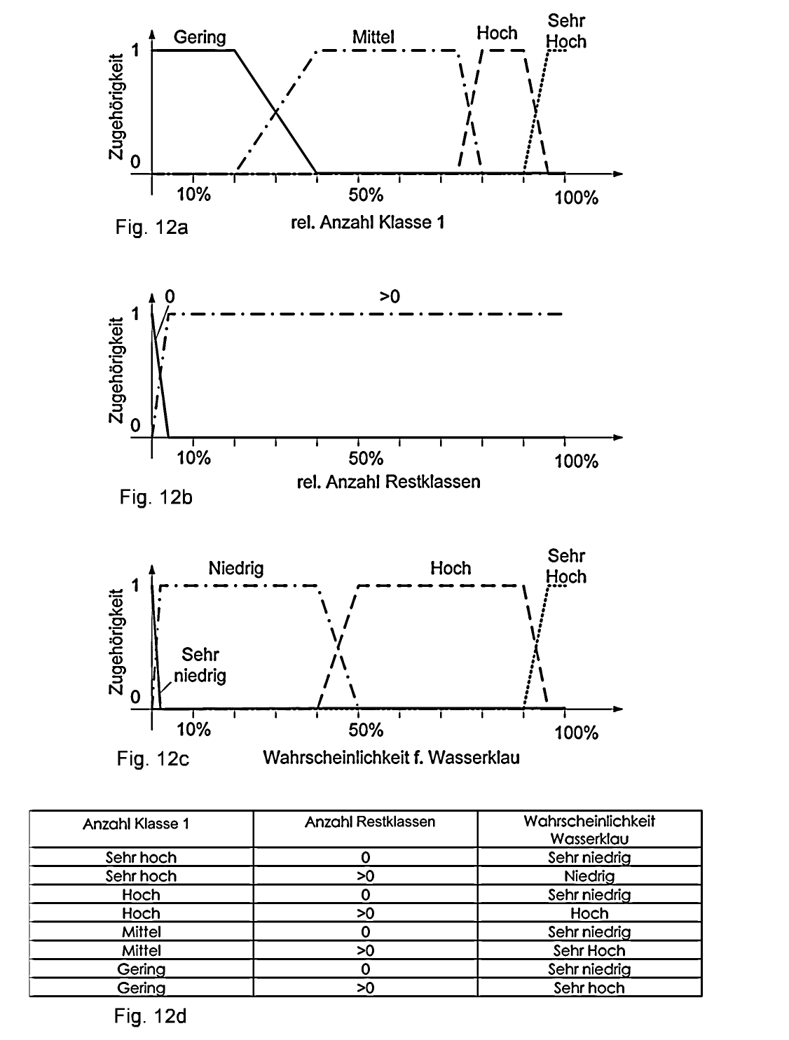

FIG. 12a shows a membership function for the relative number of entries in a first consumption flow class;

FIG. 12b shows a membership function for the relative number of entries in all other consumption flow classes;

FIG. 12c shows a membership function for summarizing the membership functions according to FIGS. 12a and 12b;

FIG. 12d shows a tabular summary for the membership functions according to FIG. 12c, and

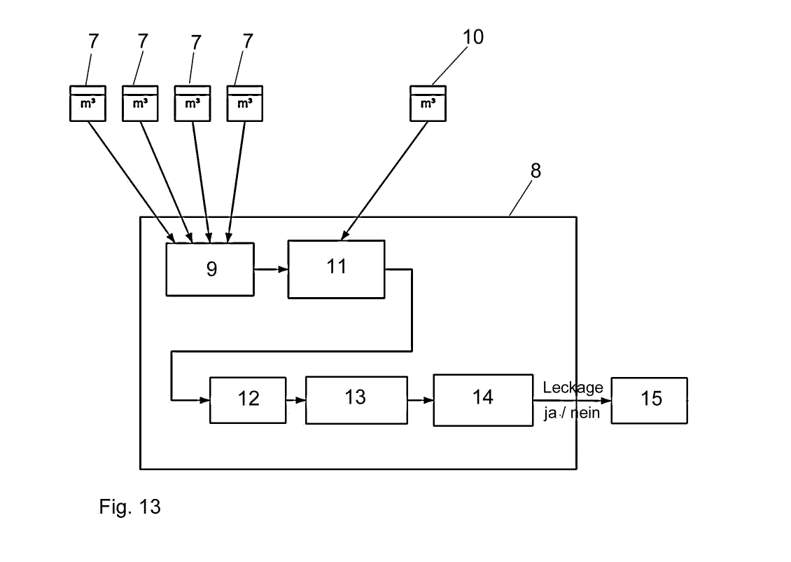

FIG. 13 schematically shows a device equipped to implement the method according to the invention as per an additional embodiment.

In the following, various embodiments of the method according to the invention for assessing the consumption of a medium in a supply distribution system will be described by using the example of a water meter as consumption meter. In this case, the consumed medium is water and the consumption flow values for the medium are volume flow values of the water flow as determined by the water meter. These volume flow values will also be described in the following in short, as volume flow.

However, the invention is not limited to the example of the water counter explained in the figures and the water supply distribution system of a building, but as explained at the beginning, it is generally usable for supply distribution systems in which a certain supply medium is made available by a supplier that is invoiced based on consumption meters. But the specifically described method represents a particularly preferred application of the method proposed according to the invention for determining consumption costs in buildings, typically single and multi-family houses, or office buildings with several tenants.

The water consumed in the building is captured by water meters so that the water supplier is able to invoice the volume of the water consumed and/or settle with the waste disposal companies for sewer usage. To make this possible, water meters then capture the volume precisely in the form of a volume flow when the water is withdrawn at a point of consumption and thereby flows through the water meter. In the case of multi-family buildings, this applies to a central building water meter as well as to each apartment water meter within its monitoring or metering area (apartment) where the removal of water (withdrawal) takes place. If there is no withdrawal, the water meter is idle and no additional volume is added to the measured consumption value. In this case, the value of the cumulative metered values (meter reading) of the water meter does not change.

The number N_{draw}_{_{—}}_{d} of water withdrawals per day in an operational state without leakage is between zero if no water was withdrawn and a finite number if water was withdrawn a certain number of times on that day. The duration Δt_{draw} of a withdrawal can differ and depends on the respective application. Thus, taking a bath or a shower requires longer withdrawal times than washing hands. Typically, the maximum duration Δtdraw of a withdrawal for a normal application in the domestic arena is less than an hour. No water is drawn, for example, when an apartment is empty or when the occupant is on vacation.

In the domestic arena, typically, the following types of leakages can occur:

### 1. Leakiness in the Distribution Network (Valves, Pipes, Pipe Connections of the Supply Distribution System or a Burst Pipe)

This type of leakage is characterized by a relatively even loss of volume that is perhaps superimposed by volume flow peaks during a withdrawal. Depending on the leakage, the level of the volume flow can extend from small to large. This type of leakage is typically present for a longer period of time.

### 2. User-Related Water Loss

A user-related water loss is typically based on a mistake made by a user, for example, when a faucet has not been turned off properly. Here as well, typically, the result is a relatively even loss-related volume flow that can be superimposed by volume flow peaks when water is withdrawn. Customarily, the volume flow in a user-related water loss is comparably small and is present over a limited period of time, namely until this unintended loss of water is identified by the user and stopped.

### 3. Water Stealing

Water stealing is described as a deliberate diversion of water to circumvent water meters. In the case of a permanent diversion, this can mean a relatively even loss-related volume flow that is superimposed by volume flow peaks upon a withdrawal. Water stealing can also occur in a diversion due to normal user-related water withdrawal if it bypasses the water meter. In this case, the “regular user withdrawal profile” and the “water stealing” user profile are superimposed. The volume flow depends on the type and the purpose for which the water is drawn.

From this it can be seen that various types of leakages having various volume flows can be present. Based on the different time response and the different volume flow depending on the type of leakage, it is difficult to distinguish by specifying specific criteria, if an undesired leakage or normal use is present in an individual case.

FIG. 1 shows a volume flow in any units as captured by a consumption meter over time in any units for an analysis interval. The volume flow representing the consumption flow values has been determined from individual metered consumption values by the consumption meter in a known manner. The volume flow diagram shown in FIG. 1 shows a popular withdrawing behavior of a user's water withdrawals from the supply distribution system, which are more or less evenly distributed over time and differentiate themselves by the level of the volume flow depending on the reason of use. The individual withdrawals of water can be identified as a specified chronological resolution by the scale on the time axis as individual amplitudes in the volume flow diagram, and are interrupted by longer periods of time, in which no water is withdrawn, i.e. the volume flow is zero.

Over the same analysis interval, FIG. 2 shows the accumulated meter reading, i.e. the chronological integral covering the volume flow as it is customarily read on a water meter. Step-like recesses can be identified in the time-behavior in which the meter reading changes significantly by more or less, followed by flat, plateaulike periods in which no water is withdrawn. Each step thus indicates a withdrawal of water or water consumption, whereby the high steps indicate that a large amount of water was withdrawn, and the lower steps that only a small amount of water was withdrawn at a certain time.

By comparison, FIG. 3 shows a flow diagram in which in addition to the individual peak-like withdrawals of water, a band of a lower volume flow can be identified that is present at a constant level over the entire analysis interval. This is caused by a leakage with a continuous, low volume flow. The pertaining meter readings diagram shown in FIG. 4 containing the cumulative metered consumption values or volume flows of the water meter shows a more or less continuous meter progression in which merely larger, superimposed withdrawals of water by the user are identifiable as steps in the otherwise straight line formed between time and meter reading.

The present invention is based on the identifiable differences in the meter readings diagrams in FIG. 2 and FIG. 4. To assess the water consumption in, for example, a building supply distribution system using a water meter, by using captured metered values of the consumption meter chronologically resolved, the volume flow of the water that has been consumed is determined. For this, the cumulative volume V_{cum} is taken into consideration that is also described as meter reading in FIGS. 2 and 4, which steadily increases when water is withdrawn for a certain duration Δt_{draw}.

By finding the difference of two accumulated volumes ΔV_{cum} between two meter readings V_{cum}(n) and V_{cum}(n+1) at times t(n) and t(n+1), the volume flow between the two measurement times t(n) and t(n+1) is obtained. In the event water was withdrawn between times t(n) and t(n+1), ΔV_{cum}>0. If no water was withdrawn between these two points in time, ΔV_{cum}=0.

If a reference or analysis interval is being considered according to the invention, for example, 24 hours, the Lime-dependent function V_{cum}(t) describing the accumulated volume is not a steadily rising curve, but has time segments in which the meter reading Vcum is constant. This can be dearly seen in FIG. 2 by the plateauformation of the step function, whereby for the implementation of the method according to the invention, the accumulated consumption value of the meter after the elapse of the—also described as analysis interval—reference period, is reset to zero respectively. The representation of the differences in meter readings as volume flow according to FIG. 1 makes it clear that in the periods of plateauformation according to FIG. 2, no water is withdrawn, i.e. a volume flow of zero is present, so that there is no change in the meter reading V_{cum} or the meter reading difference ΔV_{cum}.

For the case of a leakage shown in FIGS. 3 and 4 where water is withdrawn at a steady, low volume, which is superimposed by temporary user withdrawals at higher volume, the meter reading shows a steadily rising curve as the basic function, which is offset when the user withdrawals water within the meaning of a step function without forming a plateau. Over the entire reference or analysis interval, the difference of accumulated volumes at successive points in time is therefore >0.

To be able to easily determine and differentiate this behavior, the present invention proposes the generation of a frequency distribution from the consumption flow values (volume flow values) and an assessment of the consumption by an analysis of this frequency distribution.

According to the embodiment specifically described here, the meter readings V_{cum} that reflect the accumulated volume can be scanned regularly, for example, at intervals of one minute. From this, the average volume flow \dot{V}(n) can be calculated from the difference of accumulated volumes ΔV_{cum} at two successive points in time t(n−1) and t(n) as

$$\dot{V} ( n ) = \frac{Δ {V}_{cum} ( n )}{Δ t ( n )} = \frac{{V}_{cum} ( n ) - {V}_{cum} ( n - 1 )}{t ( n ) - t ( n - 1 )} .$$

The thus formed consumption flow or volume flow values are now summarized into a frequency distribution. To do so, the consumption flow or volume flow values for forming the frequency distribution can be associated with consumption flow classes Cᵢ and the frequency of occurrence of consumption flow values as entries can respectively be counted as entries in a consumption flow class Cᵢ. Consumption flow classes Cᵢ can also be defined by specified limit values, whereby the limit values are perhaps adjustable. Useful volume flow classes can, for example, be specified as

C1: 0≦\dot{V}<\dot{V}ₗᵢₘᵢₜ₁,

C2: \dot{V}ₗᵢₘᵢₜ₁≦\dot{V}<\dot{V}ₗᵢₘᵢₜ₂ and

C3: \dot{V}ₗᵢₘᵢₜ₂≦\dot{V}<\dot{V}ₗᵢₘᵢₜ₃,

whereby the number of classes can be adjusted as desired by defining corresponding limit values \dot{V}ₗᵢₘᵢₜᵢ. In the simplest case, only two volume flow classes Cᵢ are formed, whereby \dot{V}ₗᵢₘᵢₜ₁ can correspond to the start-up volume flow of the water meter. The start-up volume flow of a water meter is defined as the volume flow at which the water meter can reliably determine a progression.

Any withdrawal of water below the start-up volume flow is not captured and the meter does not continue to meter. For example, the start-up volume of a water meter of standard device classes C is approx. 5 l/h. For a detailed analysis, additional volume flow classes Cᵢ are then defined depending on the desired precision, whereby at least a second volume flow class C₂ means a volume flow above the start-up volume flow \dot{V}ₗᵢₘᵢₜ₁, i.e. indicates that water is withdrawn.

To create the frequency distribution, the number the volume flow values \dot{V} in a consumption or volume flow class Cᵢ is then determined respectively. A frequency distribution is generated covering a specified or specifiable analysis interval, for example, six hours, 12 hours or 24 hours, and after the elapse of the analysis interval, it is respectively generated anew, so that changes can be determined. Older analysis periods can be stored and archived as recourse and for a later comparison.

For the meter readings diagram according to FIG. 2 and the pertaining volume flow diagram according to FIG. 1, a frequency distribution according to the invention is shown in FIG. 5. In this example, a total of six consumption flow classes Cᵢ were established. The shown number of the values in the frequency distribution generated for the analysis interval is in percentages, i.e. the total number of the values is 100.

R shows that by far the largest number of volume flow values is in the first class C₁, which has reference number “0” in the diagram. In this class, the volume flow value is below the start-up volume flow of the water meter, i.e. there is no water is removed in this class or none is withdrawn. In the additional classes Cᵢ that have reference number “1” to “5”, relative to the first volume flow class C₁, there are comparatively few volume flow values that reflect individual water withdrawals using different levels of withdrawals (i.e. different volume flows).

FIG. 6 shows the frequency distribution that has been generated in an identical manner for the meter readings diagram according to FIG. 4 and the volume flow diagram according to FIG. 3. It is evident that in volume flow class C₁ with reference number “0” up to the start-up volume flow \dot{V}ₗᵢₘᵢₜ₁, no volume flow values can be found. The number of the values is zero. This is due to a continuous leakage being above the start-up volume flow \dot{V}ₗᵢₘᵢₜ₁. The values for this leakage volume flow are in volume flow class C₂, which corresponds to reference number “1” in the diagram according to FIG. 6. The number of the entries of this volume flow class C₂ is almost 100%, because continuous withdrawal of water is present at all times and is only superimposed by occasional withdrawals of water by the user, which are then found in the additional classes Cᵢ.

A possible analysis of these frequency diagrams can, according to an embodiment of the method according to the invention, be performed after the elapse of the analysis interval as follows:

First, consumption flow class Cᵢ with the highest number of values, i.e. with the most entries in the frequency distribution is determined. If more than Nₗᵢₘᵢₜ₁ (absolute) or nₗᵢₘᵢₜ₁ (relative) volume flow values \dot{V} are in class C₁, which form consumption flow class C₁ up to the start-up volume flow \dot{V}ₗᵢₘᵢₜ₁ of the water meter, most certainly, no continuous leakage is present, because in the case of a continuous leakage, no values are found in this class that displays a stopped counter in a consumption flow class. Correspondingly, a continuous leakage can be assumed if fewer than Nlimit1 (absolute) or nₗᵢₘᵢₜ₁ (relative) volume flow values are in consumption flow class Cₗ.

Even if in principle, an analysis with absolute values as well as with relative values relative to the number of entries in a consumption flow class Cᵢ is possible, a relative analysis based on the number of the total entries in the frequency distribution presents itself. If appropriate, it can be complemented by an additional absolute number limit.

A more detailed analysis requires a correspondingly larger number of consumption flow classes Cᵢ. Even in this case, the class having the highest number of values is determined that provides information about the degree of the leakage flow within the scope of the class limits in the event a leakage is present.

In this case it is also expedient to determine the absolute or relative distance of the consumption flow class Cᵢ relative to the largest number of the consumption flow class Cⱼ with the second or third largest number of values. From this, information about the constancy of the leakage flow, in particular, the leakage volume flow in the case of water or a fluid can be derived. If the distance is large, the leakage flow is within the corresponding class. If the distance between these classes is small, the leakage flow is more strongly dispersed.

For the analysis of the frequency distribution, i.e., in particular, a comparison of the number of consumption flow values with specified threshold values and/or with the number of at least one other consumption flow value is made, whereby the comparison of the consumption flow values can be made using the number of entries that were made in the respective consumption flow class.

In a further embodiment of the method according to the invention, a learning phase can be provided in which a reference frequency distribution is generated as a typical frequency distribution. It can then be compared with the actual frequency distribution for analyzing the frequency distribution. A reference frequency distribution can, for example, be learned thereby, that the consumption flow values of a reference frequency distribution that were determined are added to it. In this case as wed, first a frequency distribution is determined for an analysis interval. If the determined frequency distribution is the first frequency distribution of the learning phase, the frequencies determined for the individual classes Cᵢ are stored as reference values.

If it is not the first frequency distribution determined in the learning phase, the frequency values of the individual classes Cᵢ are determined using the following weighting:

h_{ref,i}(n)=a·h_{ref,i}(n−1)+(1−a)·h_{act,i}(n)

with h_{ref,i}(n) as relative frequency of reference class Ci at time t(n), h_{ref,i}(n−1) as relative frequency of reference class Cᵢ at time
t(n−1), h_{act,i}(n) as the relative frequency of the actual consumption flow class Cᵢ at time t(n) and a as parameter to specify the adaption speed.

Hereby, an adaptation of the analysis of consumption to the actual user behavior can occur during the learning phases in which it is known that no leakage is present, whereby due to parameter a, the adaptation speed, i.e. the speed of changes in user behavior, can be taken into consideration individually.

After the conclusion of the learning phase, the actual frequency distribution of an analysis interval can then be compared with the reference frequency distribution. Thereby, should the frequency of consumption flow values for a certain consumption flow class Cᵢ deviate by more than a configurable, absolute and/or relative amount from the value of the corresponding reference class Cᵢ of the reference frequency distribution, an abnormal behavior can be concluded, and perhaps a leakage.

Typically, a learning phase can be started after start-up or also during each phase of operation, for example, after a change of tenants or altered user habits.

FIG. 7 shows a flow diagram of a first embodiment of the method according to the invention. By means of a consumption meter 1 that is designed as a water meter in this example, e.g. an impeller water meter, the counting impulses are passed to a meter 2 that is associated with consumption meter 1, in which the meter reading is recorded as cumulative measured consumption values Vcum and can be retrieved digitally.

Within the scope of routine scanning 3 of meter 2 during specified chronological intervals, a computer unit that is not shown, for example, a microprocessor, performs a calculation 4 of a consumption flow (consumption flow value \dot{V}). This consumption or the volume flow values \dot{V} are then sorted into a frequency distribution 5 in which the number of the individual consumption flow values \dot{V} relative to the consumption flow value classes or intervals Cᵢ is determined. Subsequently, an analysis 6—implemented by a processing unit—of the frequency distribution takes place according to the previously described principles, whereby as result, an analysis message “leakage yes/no” is produced that can, if necessary, be analyzed and displayed by a central processing unit—not shown.

According to a further embodiment that can also be built into a water meter according to the invention in the previously described embodiment to detect leakages having a continuous flow, serves to identify withdrawal losses between a primary meter and one or more secondary meters. These are withdrawal losses because a withdrawal of water or medium is still captured in a primary meter, but is no longer reflected by the total reading of the secondary meters.

To detect such losses, similar to the previously described analysis, a consumption flow value is formed, whereby the consumption flow value created by this variant of the method is formed from the difference of the consumption flow values of two consumption meters. One of the consumption meters is the primary water meter in the described example and the other consumption meter is a secondary water meter, for example, of an apartment, a group of secondary water meters, for example, all apartments in a building, whereby the meter values of the secondary water meters can be totaled and can be treated as a one meter value.

Specifically, for the analysis, first the difference between the meter reading of the primary water meter and the total of the secondary water meters can be calculated. These meter readings are illustrated over a certain analysis interval in FIG. 8, whereby the curve “Primary meter” shows the meter reading of the primary water meter and the other curve “Total secondary meters” the total of the meter readings of the secondary water meters.

The difference can be obtained by the formula shown as follows

$$Δ {V}_{primary\_sub} ( n ) = {V}_{cum , primary} ( n ) - {\sum }_{i = 1}^{k} {V}_{cum , sub , i} ( n )$$

whereby V_{cum,primary} represents the cumulative meter reading of the primary meter at the time of scanning, t(n), V_{cum,sub,i}(n) the cumulative meter reading of secondary meter i at the time of scanning t(n) and k represents the number of secondary meters.

As previously explained, analogous to the previously described process relative to the embodiment, from the difference signal formed ΔV_{primary}_{_{—}}_{sub}(n), a volume flow value \dot{V}_{primary}_{_{—}}_{sub} is generated:

$${\dot{V}}_{primary\_sub} ( n ) = \frac{Δ {V}_{primary\_sub} ( n )}{Δ t ( n )} = \frac{{V}_{primary\_sub} ( n ) - {V}_{primary\_sub} ( n - 1 )}{t ( n ) - t ( n - 1 )} .$$

The volume flow values (or general consumption flow values) obtained with this calculation rule are shown for two different cases over time in FIG. 9.

In a first case, the volume flow, or the volume flow difference between the primary meter and the total of the secondary meters fluctuates in a range around 0. This has its reasons therein that the total of the secondary meter readings does not exactly coincide with the meter reading of the primary meter because of error tolerances of the individual water meters. Depending on the size of the error and the leading signs, the meter readings of a primary meter and the total of the meter readings of the secondary meters can differ to various degrees. This deviation is also evident in a volume flow difference between the primary meter and the summation of readings of the secondary meters when calculating the volume flow values. However, these fluctuations due to tolerances do not represent a leakage or water stealing. This situation corresponds to the curve for the first case in FIG. 9.

In contrast, if the volume flow difference becomes larger at certain times, i.e. if a significant deviation of the volume flow can be determined between the primary counter and the volume flow from the summation of the secondary meters, this points to a leakage or water stealing in the distribution system downstream of the primary meter. To the extent these are individual, unauthorized withdrawals of water, the volume flow difference between the primary meter and the summation of the secondary meters follows the curve labeled as second case in FIG. 9.

The frequency distribution obtained for the first case in FIG. 9 is shown in the form of a histogram in FIG. 10, whereby for the volume flow intervals with respect to volume flow classes, any units are selected. Even here, based on the described error tolerances, not all volume flow values (consumption flow values) that fall in the range around zero of the flow interval are included. A certain number of values in a volume flow interval are not zero. The percentage share of these values is, however, under 5%.

FIG. 11 shows a correspondingly calculated frequency distribution for the second case in FIG. 9. Here, most of the entries in the volume flow values are zero, even in the volume flow interval. The number of these values is, however, only approximately 65%. The remaining values are distributed over higher volume flow intervals.

In place of the volume flow intervals shown here, it would in principle also be possible to select volume flow classes corresponding to the definition in FIGS. 5 and 6 with respectively suitably defined class limits.

An analysis of the frequency distribution according to FIGS. 10 and 11 can be performed according to the following rules. Stealing of water within the meaning of an unauthorized, temporary deviation (withdrawal in a supply distribution system between the primary meter and the secondary meters is present when the relative number of values in the smallest volume flow interval relative to the smallest volume flow class is smaller than a specified limit value, and the quantity of the values in the remaining volume flow intervals relative to the remaining flow classes is larger than a specified limit value. Hereby, even the additional volume flow intervals can still be differentiated. The limit values should preferably be determined based on corresponding empirical values, whereby for the determination, the typically expected difference, depending on the device class of the water meter used and the meter reading of the primary meter and the summarized meter reading of the secondary meters, must be taken into consideration.

The corresponding limit values can, for example, be configured upon start-up. Alternatively, here as well, a system self-learning method is conceivable in which after the start of the learning process, respective frequency distributions are determined over a certain number of analysis intervals. After the frequency distribution has been calculated, the relative number of the values are identified in the smallest volume flow class or the smallest volume flow interval, and the volume flow interval, or the volume flow class is identified that still contains a relative number of values larger than 0%. For all remaining classes, the relative number of values is then equal to 0. After the conclusion of the learning phase, the arithmetic average can be calculated from all values of the individual analysis phases. These values should then be used as corresponding limit values. For a successful learning phase it is required that no water stealing occurs during the learning phase. At least in a learning phase directly after installation of the water meter, this is not expected to be the case.

A further alternative or additional possibility for analyzing the frequency distribution can be realized with the help of membership functions. For this, the relative number of consumption flow values or volume flow values is analyzed with a membership function associated with this consumption flow value, and the assessment of the membership functions of various consumption flow or volume flow values are summarized to assess overall consumption. In particular, these membership functions can be the analysis rules of a fuzzy logic.

For the second embodiment, suitable membership functions or analysis rules are shown in the following FIG. 12a to FIG. 12d. It must be pointed out, however, that the invention is not limited to use these or similar rules of analysis only when assessing a consumption flow difference between the primary meter and the total amount of the secondary meters. A corresponding analysis with the help of membership functions and/or other rules of analysis can also be achieved for the first case of analysis by using a single meter.

The membership function in FIG. 12a shows an assessment of the number of volume flow values in the first class, or the first volume flow interval, and performs an assessment of the fuzzy variables “relative number in the lowest class”. For a relative number of over 90% up to 100%, the relative number in class 1 is valued at very high. For other relative numbers in the lowest class or the lowest volume flow interval, corresponding to the drawn functions, the values are high, average and low, whereby a membership is associated with specific value numbers between 0 and 1.

FIG. 12b assesses the relative number of the remaining classes or the remaining value flow intervals. Here, the value 0 is found as the fuzzy variable “relative number in remaining classes” when in the remaining classes no, or at a maximum 5% of the entries are present. Starting at 5% of the entries, the membership function receives the value >0.

From these two values, the probability that water is being stolen can be derived, which, corresponding to the percentage found, is then assessed in a range from very low, low, high to very high.

This membership function is formed corresponding to the table in FIG. 12d, in which the fuzzy variables “relative number in the class lowest class” and “relative number in the remaining classes” is assessed and summarized in a probability that water is being stolen.

Class 1 (lowest class) and the remaining classes must preferably be selected by a suitable selection of limit values so that volume flow values that are associated with the remaining classes correspond to the unauthorized withdrawal of water and not to the deviation due to tolerances between the primary meter and the total amount of the secondary meter readings.

The example of membership functions shown here is based on a summary of all remaining classes. However, in a different embodiment of the invention, it would also be conceivable to perform various membership functions for several fuzzy variables of different remaining classes and define a corresponding expansion of the rule base to make more detailed increments of the assessment possible. Thereby, additional fuzzy variables can also be included, for example, for the relative number of values in further flow classes or flow-through volume flow intervals. Hereby, a more detailed gradation of the assessment could also be achieved.

FIG. 13 shows a system according to the invention for detecting losses due to withdrawals, or water stealing between a primary meter and a number of secondary meters. Primary meters and secondary meters can, for example, be water meters.

Specifically, several secondary meters 7 are shown that respectively form an accumulated volume flow of a secondary meter 7. These report their meter readings to a separate data receiver designed as data collection point 8 having a processing unit. When forming sum 9 in data collection point 8, the individual meter readings of secondary meters 7 are summed into a total value. Further, a primary meter 10 is shown as consumption meter that transmits its cumulative meter reading to data collection point 8 as well, which, when forming difference 11, forms the difference between the primary meter reading and the total amount of the secondary meter readings. In calculation 12, volume flow values or consumption flow values are calculated from this difference and a frequency distribution 13 is generated. Subsequently, an analysis 14 of frequency distribution 13 is performed with the result that a leakage is present or not. This result can be forwarded to a control center 15 by data collection point 8, which transmits corresponding information to the tenant or the landlord of real property in the event of a leakage, for example.

By using the analysis of the frequency distributions according to the invention based on individual consumption flow values, a better prediction can be made according to the invention as to whether there is a leakage in the supply distribution system and medium is being discharged or stolen.

### REFERENCE NUMBERS AND EQUATION SYMBOLS

1 Consumption meter, water meter
2 Meter
3 Scanning
4 Calculation of a consumption flow value
5 Frequency distribution
6 Analysis
7 Secondary meter
8 Data collection point
9 Summation/totaling of secondary meter readings
10 Primary meter
11 Difference formation of secondary meter readings relative to the
primary meter reading
12 Volume flow calculation
13 Frequency distribution
14 Analysis
15 Control center
N_{draw}_{_{—}}_{d} Number of withdrawals per day
Δt_{draw} Duration of withdrawal
V_{cum} Cumulative volumes, meter reading
ΔV_{cum} Difference of cumulative volumes
\dot{V} Average volume flow or consumption flow
Cᵢ Consumption flow classes

1-13. (canceled)

14. A method for assessing the consumption of a medium in a supply distribution system by using at least one consumption meter, in which by using the consumption values captured over time (V_{cum}) by the consumption meter, consumption flow values (\dot{V}) are determined for the medium, whereby using the consumption flow values (\dot{V}) a frequency distribution is generated by classifying the consumption flow values for generating the frequency distribution into consumption flow classes (Cᵢ) that are defined by specifiable limit values, and the respective frequency of occurrence of consumption flow values (\dot{V}) are counted as entries in a consumption flow class (Cᵢ) and whereby the consumption is assessed by an analysis of the frequency distribution,
wherein, for the analysis of the frequency distribution for detecting a leakage of the medium, the number of consumption flow values (\dot{V}) within consumption flow classes is compared with the number of consumption flow values (\dot{V}) within at least one other consumption flow class.

15. The method of claim 1, wherein the frequency distribution is generated over a specifiable analysis interval.

16. The method of claim 1, wherein for the analysis of the frequency distribution, the number of consumption flow values (\dot{V}) is compared with specifiable threshold values.

17. The method of claim 3, wherein the threshold values are learned.

18. The method of claim 1, wherein for the analysis of the frequency distribution, a reference frequency distribution is generated and compared with a frequency distribution.

19. The method of claim 5, wherein the reference frequency distribution is learned by adding the consumption flow values (\dot{V}) that were determined to the reference frequency distribution.

20. The method of claim 1, wherein for the analysis of the frequency distribution, the relative number of consumption flow values (\dot{V}) is assessed with a membership function associated with this consumption flow value (\dot{V}) and the assessments of the membership functions of various consumption flow values (\dot{V}) are summarized for an assessment of the consumption.

21. The method of claim 1, wherein the consumption flow value (\dot{V}) is formed from the difference of two consumption meters.

22. The method of claim 1, wherein the method is performed in a consumption meter or a data collection point.

23. The method of claim 1 wherein upon the detection of a leakage of the medium in the supply distribution system, the amount of the discharged medium is determined using the frequency distribution of the individual consumption values (\dot{V}).

24. A device for assessing the consumption of a medium in a supply distribution system by using at least one consumption meter, whereby the device has a memory for storing the consumption values (\dot{V}) of at least one consumption meter and a processing unit that is connected to the memory, which is equipped to assess the consumption with the help of the consumption values (\dot{V}) that were determined,
wherein the processing unit is equipped to perform the method as recited in claim 1.

25. The device as recited in claim 11, wherein the device is integrated into a consumption meter.

26. A device as recited in claim 11, wherein the device is integrated into a data collection point which is connected to at least one consumption meter.
